(19) United States
(12) Patent Application Publication
(10) Pub. No.: US 2009/0116481 A1
(43) Pub. Date: May 7, 2009

(54) On-Demand Data Delivery System

(76) Inventor: Chie ISHII, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/108,615

(22) Filed: Apr. 24, 2008

(30) Foreign Application Priority Data
Apr. 26, 2007 (JP) 2007-116676

(51) Int. Cl. H04L 12/56

(52) U.S. Cl. 370/390

(57) ABSTRACT

It is provided a data delivery system of hybrid type in which a multicast delivery and a unicast delivery are combined. The system has a multicast delivery server and a unicast delivery server which have the same content data. A terminals has functions of a reception control, a multicast reception, a unicast reception, a playback control and a data playback. The multicast delivery server delivers a content by multicast at a certain fixed interval. When a content delivery request is made by a user, the user terminal immediately starts reception of the multicast delivery which began latest and, receives data from a head of the content till the time point of the start of the reception as lack in the multicast delivery data, individually by unicast. The user first starts browsing with the unicast data and, thereafter switches the unicast data to the accumulated multicast data.

### BACKGROUND OF THE INVENTION

1. Field of the Invention

The present invention relates to a data delivery system of on-demand.

2. Description of Related Art

Heretofore, a unicast communication from a server to a terminal has been utilized in a data (video content data, dynamic image content data) delivery of on-demand. Since the unicast communication is a communication of one-to-one correspondence, separate deliveries need to be performed for individual terminals.

Besides, a delivery apparatus which performs multicast deliveries is disclosed in, for example, JP-A-2004-135239.

With the disclosed delivery apparatus, in a case where a delivery request has been made by a new reception apparatus during the multicast deliveries of the delivery apparatus, a delivery acknowledgment packet containing a multicast address is sent back from the delivery apparatus to the reception apparatus. The reception apparatus notifies the serial No. of a received first content packet to the delivery apparatus, thereby to make a request for delivered data. The delivery apparatus transmits the delivered data to the reception apparatus in pauses of the multicast deliveries.

Besides, JP-A-2005-277946, for example, discloses a technique wherein, in compliance with a request made to view a certain program, the stream data of a channel which started the delivery of the program in the nearest past are received by a near VOD (Video On Demand) scheme and are written into a video memory, while the stream data which have already been delivered in the channel are received by a unicast scheme and are outputted to a video display device, and after the end of the output of the data, the video memory is controlled so as to perform the time shift playback of a video signal received by the near VOD scheme.

### SUMMARY OF THE INVENTION

In data deliveries of on-demand, unicast communications from servers to terminals are utilized, and hence, a traffic increases in the existence of a large quantity of delivery requests. Therefore, a load is exerted on a network, and heavy loads are simultaneously exerted on the servers. Countermeasures, such as the distributive arrangement of the servers and the compression of data, are considered, but the deliveries cannot help being limited in a case where delivery requests for high-quality data have been generated in large quantities by users in a wide area. It is also considered to enhance a delivery efficiency by one-to-N communications based on multicast. However, the multicast deliveries are real-time deliveries, and all the users cannot receive the data from the heads thereof though they can receive the data from the intermediate parts thereof. Therefore, the multicast deliveries are sometimes inapplicable to the on-demand deliveries which comply with the requests of the respective users.

In view of the above drawbacks, the present invention has for its object to provide an on-demand data delivery system of hybrid type in which multicast deliveries and unicast deliveries are combined. Another object of the invention is to reduce loads on servers and a network in a data delivery service of on-demand.

In order to accomplish the objects, a multicast delivery server and a unicast delivery server which have the same content data are prepared as servers which perform data deliveries. Besides, each user terminal is furnished with a reception control function, a multicast reception function, a unicast reception function, a playback control function and a data playback function.

The multicast delivery server delivers contents by multicast at certain fixed intervals.

In a case where a content delivery request has been generated by a user, the user terminal immediately starts receiving a multicast delivery which began latest, and it receives data from a head to the time point of the start of the reception as lack in the data of the multicast delivery, individually by unicast. The user first starts browsing with the unicast data, and he/she switches the unicast data to the accumulated multicast data midway and browses the multicast data.

For example, in a system in which video content data is delivered in on-demand fashion in volume;

an on-demand data delivery system comprising:

a multicast delivery server which includes means for delivering the video content data by multicast communications at intervals of a fixed time period;

a unicast delivery server which includes means for delivering the video content data by unicast communications in compliance with requests from a user terminal;

a content server in which content data to be delivered by said multicast delivery server and said unicast delivery server are stored; and

the user terminal;

wherein,

the user terminal includes:

means for receiving the content data from said multicast delivery server and for storing the received content data in a memory;

means for requesting said multicast delivery server to delivery;

means for confirming a lacking time period of the received content data;

means for requesting said unicast delivery server to deliver lacking content data;

means for receiving the content data from said unicast delivery server; and

means for playing back the content data;

further wherein,

when the user terminal requests content delivery, said user terminal immediately starts the reception of data of the multicast delivery which began latest and, receives data from a head of the video content data till a time point of the start of the reception as lack in the multicast delivery data, individually by unicast, whereby browsing is first started with the unicast data and, the unicast data are thereafter switched to the accumulated multicast data, which are browsed. In the on-demand data delivery system described above, the number of users who make the delivery requests is monitored in said multicast delivery server, so as to set a delivery start cycle of said multicast delivery server at an optimum value.

### BRIEF DESCRIPTION OF THE DRAWINGS

FIG. 1 is a block diagram showing the configuration of an on-demand data delivery system in an embodiment of the present invention;

FIG. 2 is a diagram for explaining an example of multicast deliveries;

FIG. 3 is a block diagram showing an example of the configuration of a terminal;

FIG. 4 is a diagram showing an example of a system sequence in the embodiment;

FIG. 5 is an image diagram showing an example of content data;

FIG. 6 is an image diagram showing an example of a traffic; and

FIG. 7 is a graph showing an example of required bandwidths.

### DETAILED DESCRIPTION OF PREFERRED EMBODIMENTS

Now, embodiments of the present invention will be described with reference to the drawings.

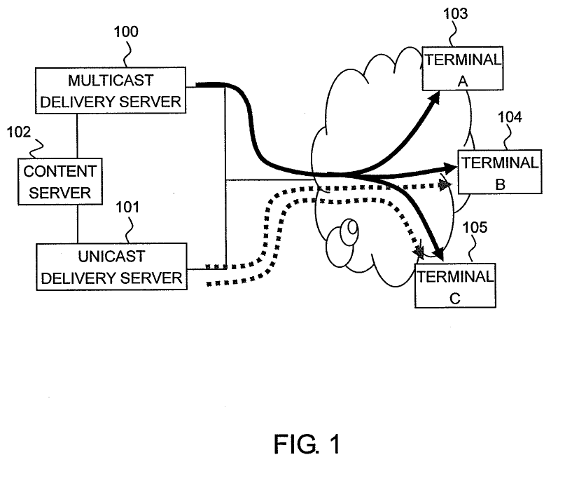

FIG. 1 shows a configurational diagram of an on-demand data delivery system. The system includes a multicast delivery server 100, a unicast delivery server 101, a content server 102, and a terminal 103.

Content data stored in the content server 102 can be divided every time period, and they are controlled in the unicast delivery server 101 and the terminal 103 by using time stamps which they have.

The unicast delivery server 101 has the function of delivering by unicast, the content data for a time period as requested by a terminal 104.

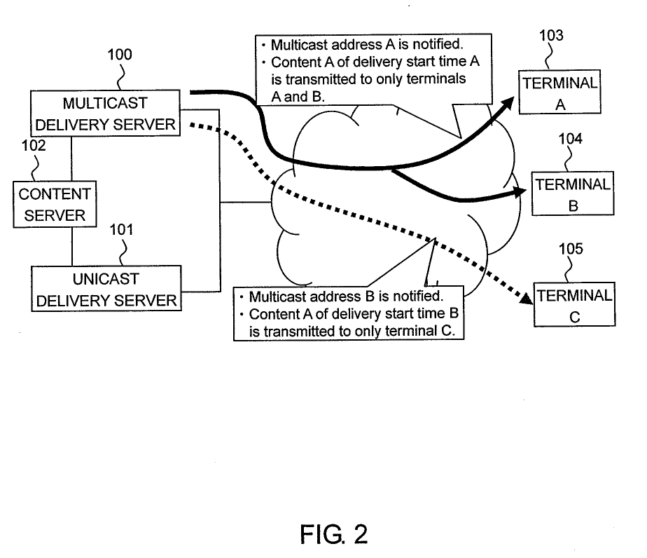

The multicast delivery server 100 has the functions of allocating the multicast address of a transmission destination to a content each time a content delivery is started, and notifying the multicast address of the content to-be-delivered to the terminal 104 in a case where a delivery request has been made by the terminal 104 (refer to, for example, FIG. 2).

Incidentally, regarding the distribution of multicast addresses, a DHCP server can be separately installed and used instead. In a case where a plurality of multicast delivery servers are installed, it is also considered to perform the centralized management of the addresses by the DHCP server.

Here, it is assumed by way of example that the multicast delivery server 100 starts the delivery of a content A of 120 minutes every 30 minutes. Besides, it is assumed by way of example that an address A is a multicast address allocated to the content A which was started its delivery at a certain time A, while an address B is a multicast address allocated to the content A which was started its delivery at a time B.

When the multicast delivery server 100 performs the content delivery, it allocates the multicast address to the content to-be-delivered. The multicast delivery server 100 designates the allocated multicast address as a transmission destination address, and starts the delivery.

In a case where the terminal 103 (terminal A) has made a delivery request for the content, the multicast delivery server 100 notifies to the terminal 103, the multicast address A allocated to the content A which was started its delivery latest. The terminal 103 registers the address A as the multicast address, and starts the reception of the content A.

In a case where the received content A is assumed to have lapsed for 10 minutes since the start of the delivery, the content which the terminal 103 can receive from the multicast delivery server 100 becomes data from 10 minutes after the start. Therefore, the terminal 103 receives data for 10 minutes from a head to the time point of the start of the reception as lack in content data from the multicast delivery server 100, from the unicast delivery server 101 while retaining the content data received from the multicast delivery server 100, in a memory.

In the terminal 104, the data for 10 minutes from the head are first browsed with the unicast data, and they are thereafter switched to multicast data accumulated in a memory 202, so as to browse the multicast data.

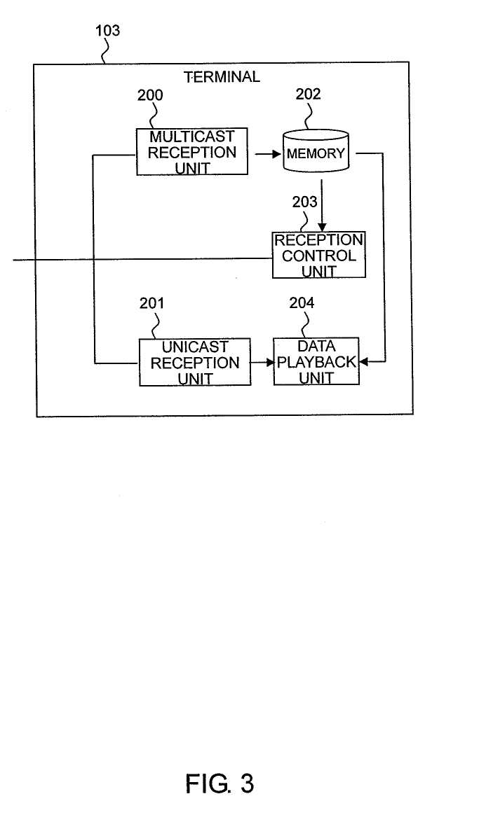

FIG. 3 shows a configurational diagram of the terminal 103. The terminal 103 includes a multicast reception unit 200, a unicast reception unit 201, a memory 202, a reception control unit 203, and a data playback unit 204. Incidentally, the configuration of any other terminal is the same.

In the multicast reception unit 200, content data are received from the multicast delivery server 100 by multicast, and they are retained in the memory 202. In the reception control unit 203, a request for delivery is made to the multicast delivery server 100, the lacking time period of the content data received from the multicast delivery server 100 is confirmed, and a request for the delivery of lacking content data is thereafter made to the unicast delivery server 101. In the unicast reception unit 201, the content data are received from the unicast delivery server 101 by unicast so as to play back the content data by the playback control unit (data playback unit) 204. In the data playback unit 204, after the content data received by the unicast reception unit 201 have been played back, the content data retained in the memory 202 are played back.

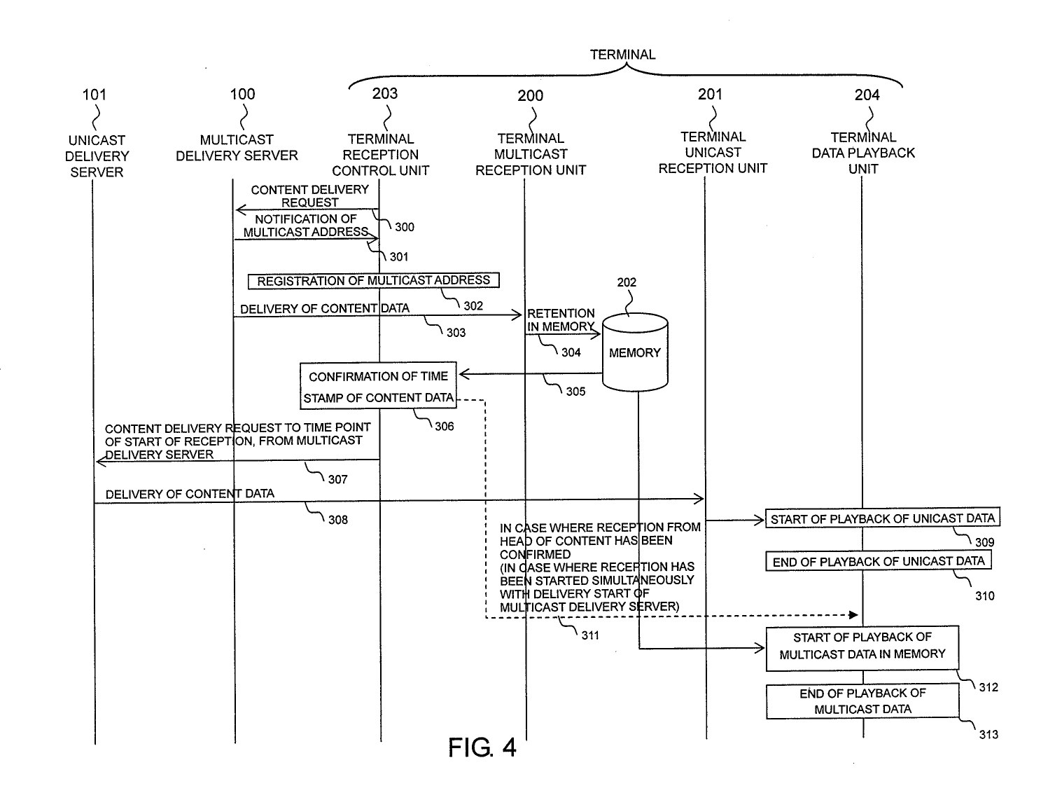

FIG. 4 shows a sequence diagram of the system. When the user of the terminal 103 browses a content, the reception control unit 203 of the terminal 103 first transmits a content delivery request to the multicast delivery server 100 (300). Incidentally, the terminal 103 can previously know the address of the multicast delivery server 100 or an initial address for the content delivery request. In response to the content delivery request from the terminal 103, the multicast delivery server 100 notifies to the terminal 103, a multicast address allocated to the content which was started its delivery latest (301). The terminal 103 registers the address (for example, the address A) notified by the multicast delivery server 100, as the multicast address (302).

The content for which a transmission designation address is designated as the address A, is delivered from the multicast delivery server 100 to the terminal 100 by multicast (303).

In the terminal 103, content data delivered from the multicast delivery server 100 are received by the multicast reception unit 200 and are retained in the memory 202 (304).

In the reception control unit 203, the time stamp of the content data received from the multicast delivery server 100 is referred to (305), so as to confirm how many minutes the received content data lacks from the head of the content (306). Here, it is assumed by way of example that the content data received from the multicast delivery server 100 are data from 10 minutes after the start of the delivery of the content.

Subsequently, the reception control unit 203 makes a delivery request for content data for 10 minutes from the head, to the unicast delivery server 101 (307). The content data delivered from the unicast delivery server 101 are received by the unicast reception unit 201 (308), and the playback thereof is started by the data playback unit 204 (309).

At the same time that the playback for 10 minutes from the head have been completed (310), the data playback unit 204 derives the content data from 10 minutes after the start of the content, from the memory 202 and plays back the derived content data (312 and 313).

Likewise, in a case where the terminal 104 (terminal B) has made a delivery request for the content, 25 minutes after the start of the multicast delivery, this terminal 104 individually receives content data for 25 minutes from the head, by unicast, and it receives content data for the remaining 95 minutes, by multicast.

On the other hand, in a case where a terminal 105 (terminal C) has made a delivery request for the content, simultaneously with the delivery start of the multicast delivery server 100, the terminal 105 can receive all multicast data, and hence, it performs reception from the start till the end of the content by multicast.

A sequence on this occasion will be explained with reference to FIG. 4. In a case where the reception from the head of the content has been confirmed (311) by referring to the time stamp of the content data received from the multicast delivery server 100, in the reception control unit 203 (306), the content data are derived from the memory 202 and are played back (312 and 313).

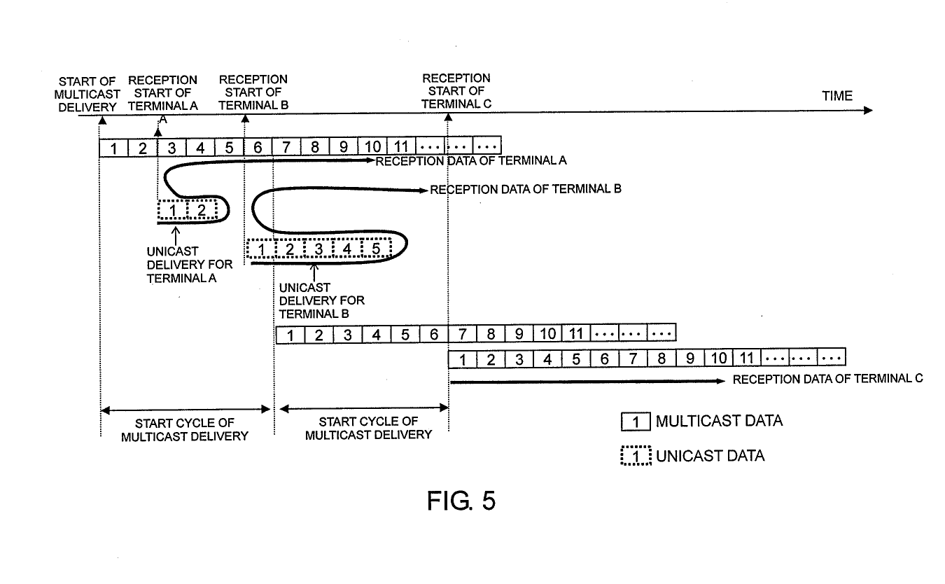

FIG. 5 shows an image diagram of the content data which the terminal 103 (terminal A), terminal 104 (terminal B) and terminal 105 (terminal C) receive, respectively, on the basis of the above example. Here, the content data are indicated by being divided in units of 5 minutes. Besides, the data are denoted as “1”, “2”, etc. in correspondence with the time stamps.

The terminal 103 receives data “1” and “2” by unicast, and data “3” et seq. by multicast. The terminal 104 receives data “1” to “5” by unicast, and data “6” et seq. by multicast. The terminal 105 receives all data by multicast.

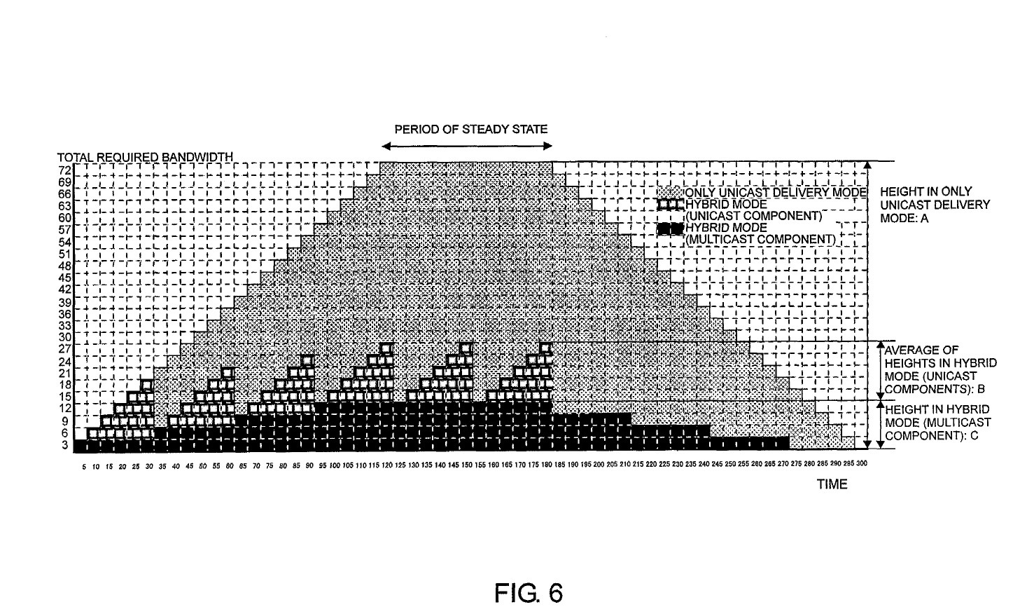

FIG. 6 shows a traffic image. The figure shows the totals of required bandwidths in the case where the multicast delivery server starts the delivers of a content of 120 minutes every 30 minutes, and where users make content delivery requests at intervals of 5 minutes.

A “complete unicast delivery mode” corresponds to the required bandwidth in the case where the unicast delivery is performed as in the prior art, while a “hybrid mode” corresponds to the required bandwidth in the case where the delivery method of this embodiment is employed. The difference of the bandwidths becomes a bandwidth which can be reduced in the case of employing the delivery method of this embodiment, and the load of the server is simultaneously reduced.

Here, how much the load can be reduced will be calculated. In the case where the content is continuously delivered, the required bandwidth becomes the value of a “period of steady state” in FIG. 6, and hence, the average of the heights of the graphs of the “hybrid mode” and the height of the graph of the “complete unicast delivery mode” will be compared in the period.

Letting the length of the content be L minutes, the occurrence cycle of the transmission request be N minutes, the transmission start cycle of the multicast delivery server be m minutes, and “1” denote the required bandwidth in the complete unicast delivery mode, the heights of the graphs in the complete unicast delivery mode, the average in the hybrid mode (unicast components), and in the hybrid mode (a multicast component) become as given below, respectively.

Height in Complete unicast delivery mode=A=L/N

Height of Average in Hybrid mode (Unicast components)=B=(m/N−1)×(1/2)

Height in Hybrid mode (Multicast component)=C=L/m

Accordingly, the required bandwidth (X) in the hybrid mode can be calculated by the following computation formula:

X=(B+C)/A=((m/N−1)×(1/2)+L/m)/(L/N) (1)

A=0.271 is obtained when computed under the conditions of the (length of the content) L=120 minutes, the (occurrence cycle of the transmission request) N=5 minutes and the (transmission start cycle of the multicast delivery server) m=30 minutes on the basis of the example in FIG. 6. Thus, it is understood that the load can be reduced to 27% by using the scheme of this embodiment.

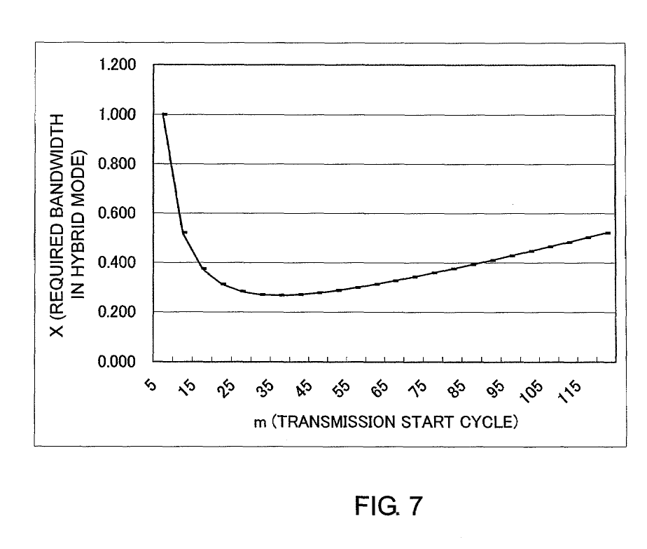

Besides, the optimum time period of the delivery start cycle of the multicast delivery server can be calculated using the computation formula. In the case, for example, where the (length of the content) L=120 minutes and the (occurrence cycle of the transmission request) N=5 minutes hold, the variable m which minimizes the required bandwidth X is 35. It is accordingly understood that the delivery is the most efficient when the delivery start cycle of the multicast delivery server is 35 minutes (FIG. 7). FIG. 7 graphically shows the change of the required bandwidth X versus the change of the transmission start cycle m in the above example.

In this manner, the transmission start cycle which minimizes the required bandwidth X can be calculated on the basis of the length L of the content and the occurrence cycle N of the transmission request from the above formula (I). The multicast delivery server can deliver the content data in accordance with the calculated transmission start cycle.

### Modified Embodiment

This example presents a system in which the function of monitoring the number of users who make delivery requests is added to the embodiment described above.

In the foregoing embodiment, it is premised that the multicast delivery server starts delivery every fixed time period. However, it is inferior in efficiency that, in a case where few users make the delivery requests, the multicast delivery server starts the delivery upon the lapse of the fixed time period in spite of the nonexistence of any delivery request. To the contrary, in a case where many users make the delivery requests, unicast deliveries increase when the delivery start cycle of the multicast delivery server is long.

In order to solve this problem, the number of the users who make the delivery requests is monitored, and the delivery start cycle of the multicast delivery server is set at the optimum value, thereby to realize an efficient content delivery.

The multicast delivery server 100 counts the number of the users who make the delivery requests, and it calculates the transmission-request occurrence cycle N every fixed time period so as to obtain the variable m which minimizes the value A in the computation formula (I), thereby to calculate the optimum multicast delivery cycle. Thus, the multicast delivery server 100 is permitted to perform the delivery in the optimum multicast delivery cycle.

By the way, in a case where no delivery request exists in spite of the lapse of the fixed time period, the delivery from the multicast delivery server is started when the delivery request from the user has been first made after the lapse of the fixed time period, whereby the delivery can be performed more efficiently.

According to the invention, it is possible to provide an on-demand data delivery system of hybrid type in which a multicast delivery and a unicast delivery are combined. Besides, according to the invention, loads on servers and a network can be reduced in a data delivery service of on-demand.

What is claimed is:

1. In a system in which video content data is delivered in on-demand fashion;
an on-demand data delivery system comprising:
a multicast delivery server which includes means for delivering the video content data by multicast communications at intervals of a fixed time period;
a unicast delivery server which includes means for delivering the video content data by unicast communications in compliance with requests from a user terminal;
a content server in which content data to be delivered by said multicast delivery server and said unicast delivery server are stored; and
the user terminal;
wherein,
the user terminal includes:
means for receiving the content data from said multicast delivery server and for storing the received content data in a memory;
means for requesting said multicast delivery server to delivery;
means for confirming a lacking time period of the received content data;
means for requesting said unicast delivery server to deliver lacking content data;
means for receiving the content data from said unicast delivery server; and
means for playing back the content data;
further wherein,
when the user terminal requests content delivery, said user terminal immediately starts the reception of data of the multicast delivery which began latest and, receives data from a head of the video content data till a time point of the start of the reception as lack in the multicast delivery data, individually by unicast, whereby browsing is first started with the unicast data and, the unicast data are thereafter switched to the accumulated multicast data, which are browsed.

2. An on-demand data delivery system as defined in claim 1, wherein the number of users who make the delivery requests is monitored in said multicast delivery server, so as to set a delivery start cycle of said multicast delivery server at an optimum value.
